(19) United States
(12) Patent Application Publication
(10) Pub. No.: US 2026/0133961 A1
(43) Pub. Date: May 14, 2026

(54) AUTOMATIC REDO GENERATION PRIORITIZATION

(71) Applicant: Oracle International Corporation, Redwood Shores, CA (US)

(72) Inventors: Chi Cao Minh, San Mateo, CA (US); Yunrui Li, Los Altos, CA (US); Mahesh Baburao Girkar, Los Altos, CA (US); Akshay D. Shah, Sunnyvale, CA (US); David Gagne, Goffstown, NH (US); Ayush Agrawal, Mountain View, CA (US)

(21) Appl. No.: 18/946,462

(22) Filed: Nov. 13, 2024

(51) Int. Cl. G06F 16/23

(52) U.S. Cl. CPC G06F 16/2379

(57) ABSTRACT

Herein is database transaction throttling to compensate for excessive redo generation and excessive database replication lag. Each time interval in a sequence of contiguous time intervals is assigned to a distinct respective redo counter in a circular buffer. While executing database statements in a database transaction, some of the redo counters are adjusted to reflect a fluctuating amount of redo generated by the transaction. When the redo generation rate of the database transaction is detected as exceeding a threshold, execution of the database statements in the database transaction is paused.

### FIELD OF THE DISCLOSURE

This disclosure relates to database transaction throttling to compensate for excessive redo generation and excessive database replication lag.

### BACKGROUND

Write-Ahead Logging (WAL) is a technique used in a database system to ensure data durability and consistency. WAL works by recording changes to data before the changes are physically applied to the database. When a transaction begins, the database creates a new log record to track changes that will be made during the transaction. As the transaction proceeds, changes that the transaction makes to data are first recorded as redo records (herein after “redo data”) in a redo log file. Redo data may include before and after values of modified data. Redo recording entails writing to a durable storage medium, such as disk or flash storage. This ensures that the changes are persisted even if the database crashes. After the redo data is persistently logged, the changes to the physical data on disk are applied to the database.

WAL ensures that data changes are persisted to disk as persistently stored redo data before the changes are applied to the database, which makes the data more durable in the event of a system failure. WAL helps to maintain data consistency by ensuring that all changes to data are persisted in a redo log file before the changes are acknowledged as committed. This helps to prevent data corruption and inconsistencies. In the event of a system failure, WAL can be used to recover the database to a consistent state. The database can replay the log records to undo any uncommitted changes and redo any committed changes.

A database batch job that generates much redo data can have significant negative impacts on a database system, especially in an OLTP environment. When a batch job generates a large amount of redo data, this can quickly fill up a redo log buffer. This can cause OLTP sessions to stall as they wait for redo log buffer space to become available. This can further cause database deceleration.

In a synchronous standby configuration, the primary database should, before committing a transaction, wait for a standby to acknowledge receipt of redo data. If the standby is struggling to keep up with the redo generated by the batch job, then commit latencies on the primary can increase.

With a synchronous standby, the redo must be persisted on both the primary and the standby before the acknowledgement is sent. Since persisting on the standby requires network I/O, it is typically slower than persisting on the primary. Batch jobs increase the amount of redo that needs to be persisted, thus increasing latency. With an asynchronous standby, the primary database can commit transactions without waiting for acknowledgment from the standby. However, if the standby is unable to keep up with redo generated by a batch job, then replication lag increases. This increases the risk of data loss in the event of a database failover because the standby might not have received all of the redo data.

Mitigation of replication lag may include any of the following state of the art techniques. A batch job may be scheduled for off-peak hours to reduce the impact on OLTP workloads. A batch job may be laboriously optimized to minimize the amount of redo generated. Replication lag may be decreased by state of the art upscaling of a resource such as by increasing network speed or bandwidth or by increasing CPU resources of a standby during recovery.

### BRIEF DESCRIPTION OF THE DRAWINGS

In the drawings:

FIG. 1 is a block diagram that depicts an example database management system (DBMS) that comprises a database server that throttles an ongoing database transaction to compensate for an excessive redo generation rate or excessive database replication lag;

FIG. 2 is a flow diagram that depicts an example process that a database server may perform to throttle an ongoing database transaction to compensate for an excessive redo generation rate or excessive database replication lag;

FIG. 3 is a flow diagram that depicts example activities that a database server may perform to throttle an ongoing database transaction to compensate for an excessive redo generation rate or excessive database replication lag;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is innovative and adaptive database transaction throttling to compensate for excessive redo generation and excessive database replication lag. This approach automatically detects a database session that is generating a large amount of redo quickly. Excessive redo generation by a database transaction in an intensive batch job is detected and throttled in real-time when there is high utilization of scarce database resources by a local database or by a dependent database. Throttling batch job redo generation offers several benefits including: decreased redo log buffer contention for OLTP sessions, decreased replication load on a standby database, and decreased data loss when failing over to the standby database.

If a database session generates redo much more and much faster than average, the session may need to be throttled when resource utilization of the local database or a replica database is high. To determine which database sessions have a current transaction whose generated redo is much larger than average, each session maintains its own current transaction redo size and stores the distribution of its transaction redo sizes using a fixed amount of memory. The general strategy is to maintain some statistics about the redo size. These statistics are maintained at a session level and aggregated to an instance level. One example approach for maintaining statistics is to model the transaction redo sizes as a normal distribution, which is efficiently represented by only recording the mean and variance. Each database session has its own measured private statistical distribution, and distributions from multiple sessions are merged into a global distribution, which also uses a fixed amount of memory. Merging normal distributions is done efficiently as follows. A sliding window over time is achieved by having a circular buffer whose elements are each a distribution and correspond to contiguous time ranges. The circular buffer has a fixed size and uses a fixed amount of memory.

To determine which database transaction generates redo faster than average, each database session's redo generation rate is calculated using a fixed amount of memory. In an embodiment, each time a database transaction generates redo data, the transaction uses the current timestamp (e.g., unix timestamp in seconds) to index into a circular buffer of numbers and increment the circular buffer element by a number of redo data bytes being generated. Any circular buffer elements that correspond to time periods when no redo is generated may have a value of zero. If the circular buffer has sixty elements and second timestamps are used, then summing the numeric values in the circular buffer gives the amount of redo generated in the past minute. Circular buffers from different database transactions are merged across sessions into a single global circular buffer that has timestamp-indexed elements each with two values: the sum of redo bytes generated for that timestamp and the total amount of time spent generating redo for that timestamp.

In one embodiment, determining when a session exceeds a threshold redo generation rate is done in constant time and space by using a token bucket algorithm. In one example, if the threshold is twice the average redo generation rate of 20 bytes/second, then a token bucket can be initialized with a maximum of 40 tokens, with a new token added every second. When a database session generates redo, it updates its token bucket by removing tokens equal to the number of bytes it is generating. If the tokens in the bucket run out, then the session is detected and marked as exceeding the threshold redo generation rate.

A database session may have its redo generation throttled while utilization of a database resource exceeds a utilization threshold. Throttling can be accomplished by having the database session sleep when it is not holding any resources. For example, when redo log buffer utilization is over 80%, a database session that is generating redo quickly for a large transaction may be forced to sleep whenever the transaction initiates pinning a buffer cache entry to store the transaction's redo. That sleep of the large transaction lasts until redo log buffer utilization drops below 80%. Additionally in an embodiment, if the redo transport lag to a standby database exceeds 10 seconds or redo application on the standby database is lagging the primary database by more than 1 minute, then the redo generation rate for a session can be capped by having a database transaction sleep when the transaction exceeds a threshold redo generation rate.

Innovations with this approach include automatic and accurate classification of batch job transactions. This provides real-time (i.e. sub-second) activation of throttling at the granularity of an individual transaction. This approach has a fixed memory cost per database session. With those innovations, redo generation prioritization is automatic, unlike other solutions that require a user to specify a target process or session.

### 1.0 Example Database Management System And Computer(S)

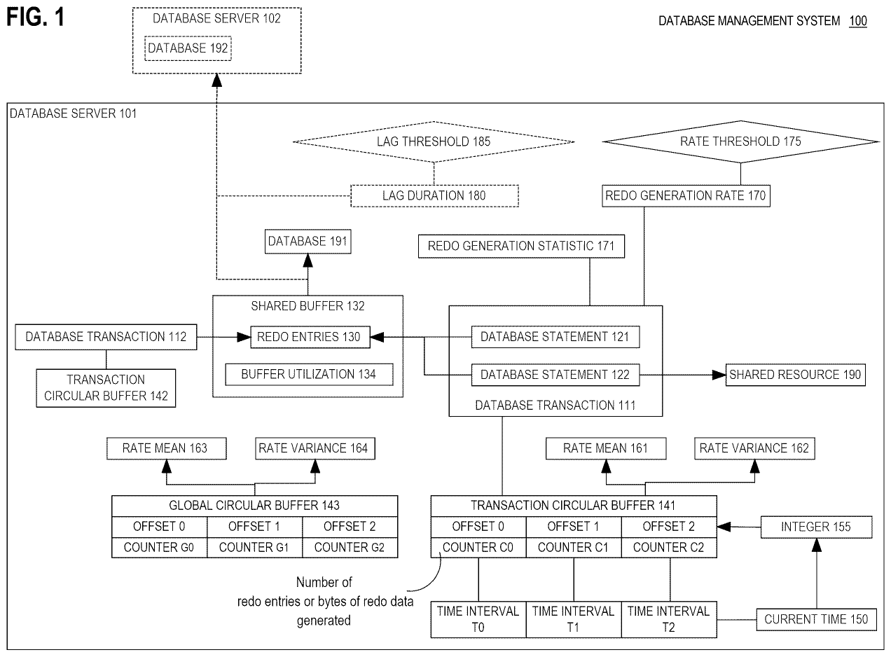

FIG. 1 is a block diagram that depicts example database management system (DBMS) 100. In a replicated embodiment, DBMS 100 contains all components shown in FIG. 1. DBMS 100 contains database server 101 that is configured to throttle ongoing database transaction 111 to compensate for excessive redo generation rate 170 and, in the replicated embodiment, compensate for excessive database replication lag duration 180. Components 102, 180, 185, and 192 are shown with dashed outlines to indicate that in a non-replicated embodiment, components 102, 180, 185, and 192 are absent and unimplemented.

DBMS 100 contains one or more computers such as a rack server such as a blade, a mainframe, a virtual machine, or other computing device. For example, each of database servers 101-102 may be contained and operating within a distinct respective computer or virtual machine. All components shown in FIG. 1 may be generated or operated in volatile or nonvolatile storage in computer(s) in DBMS 100.

The following are mutually-exclusive embodiments A-C: A) DBMS 100 consists solely of database server 101, B) database 191 is a primary (i.e. active) database and database 192 is a secondary (i.e. standby) database, or C) databases 191-192 both are active replicas that are respective database instances of one multi-instance database. In an embodiment, DBMS 100 is a relational DBMS (RDBMS) and databases 191-192 are relational databases.

### 1.1 Relational Database Technology

In an embodiment, database replication (i.e. synchronization) is unidirectional, such as with data transmitted from an active database to a standby database. In another embodiment, database replication is bidirectional, and database servers 101-102 may both share data with each other. Replication data may be sent as follows.

In an embodiment, replication is from relational database 191 to relational database 192. In operation, database 191 executes database statements 121-122 that may each, for example, be a structured query language (SQL) statement such as data manipulation language (DML) that changes content values in relational table(s) (not shown) in database 191. For example, DBMS 100 may perform online transaction processing (OLTP). Each of database statements 121-122 may be a DML statement or, in some examples, a data definition language (DDL) statement that modifies the relational schema of database 191. Relational database architecture is discussed later herein.

Database statements 121-122 are one or more SQL statements executed in database transaction 111 that may, for example, be an atomic, consistent, isolated, durable (ACID) transaction. Each of database transactions 111-112 may make many changes to database 191.

For example, database 191 may contain a relational table that contains many rows and columns, and each of database statements 121-122 may write new values into many rows, many columns, and many tables. Each column has a respective datatype that may, for example, be a scalar such as text (i.e. a character string) or a number.

### 1.2 Redo Entries

Values to be written into database 191 by database transactions 111-112 are described by redo entries 130. In an embodiment, each of database statements 121-122 may write many values, many rows, and many columns. In an embodiment, a data cell contains one scalar value in a relational table at the intersection of one row and one column. In an embodiment, a separate redo entry is generated for each data cell written. For example, writing a same value into two columns in a same row may entail two redo entries. Likewise, writing a same value into two rows in a same column may entail two redo entries. Likewise, writing two distinct values in sequence into a same data cell may entail two redo entries. A redo entry may record any fine-grained change that may occur by create, read, update, delete (CRUD) activity by database statements 121-122.

Redo entries 130 is a sequence of multiple redo entries contiguously stored in shared buffer 132 in random access memory (RAM) in database server 101. In an embodiment, shared buffer 132 is a one-dimensional array of redo entries.

In one scenario, all of redo entries 130 are caused only by execution of either one of database statements 121-122. In another scenario, redo entries 130 consists solely of two subsets of redo entries that are respectively caused by execution of respective database statements 121-122 in one database transaction 111. In another scenario, redo entries 130 consists solely of two subsets of redo entries that are respectively caused by respective database transactions 111-112. In any of these scenarios, a database transaction may be uncommitted while the transaction's redo entry resides in shared buffer 132. For example, before a commit of database transaction 111 is requested, database transaction 111 may generate redo entries 130 that initially reside in shared buffer 132 while database transaction 111 is uncommitted.

### 1.3 Flushing Shared Buffer

Whether or not redo entries of database transaction 111 are retained in shared buffer 132 after database transaction 111 is committed depends on the embodiment. For example, an embodiment may flush (i.e. clear) shared buffer 132 when database transaction 111 is committing, after which shared buffer 132 does not retain redo entries 130.

Shared buffer 132 may also flush when full (i.e. overflow) even if it contains a redo entry of an uncommitted transaction. Depending on the embodiment, flushing shared buffer 132 may entail appending redo entries 130 to a persistent log file (not shown) or may entail applying redo entries 130 to database 191. For example, flushing shared buffer 132 may entail moving or copying redo entries 130 into a persistent log file.

Shared buffer 132 overflowing is not the only technical challenge of voluminous redo generation by database transactions 111-112. Technical problems of excessive redo generation also include: a) exhaustion of a pool of shared buffers that contains shared buffer 132, b) waiting (i.e. deceleration) for an unavailable shared buffer, and c) input/output (I/O) waiting (IOWAIT) for seek latency and rotational latency of a disk that contains the persistent log file. In the state of the art, these deceleration due to waiting could, during high replication load, lead to more data loss in the event of a failover to a standby database.

### 1.4 Database Transaction Throttling

Herein, a database transaction that generates excessive redo entries will be throttled. Herein, throttling entails blocking, deactivating, pausing, suspending, or sleeping any of: the database transaction, the transaction's computational thread or process, the transaction's database session, or the transaction's database connection or network connection. Throttling may be temporary. For example, database transaction 111 may sequentially: 1) partially execute, 2) become throttled, 3) become unthrottled (i.e. resume execution), 4) become throttled again, and so forth. A database transaction is initially unthrottled. A read-only transaction does not generate a redo entry and is never throttled, even if DBMS 100 does not detect that the transaction is read only. For example, a database transaction is read only if it consists solely of SQL SELECT queries. Likewise, a database transaction that consists mostly (but not entirely) of SELECT queries will not be throttled so long as the transaction has not yet generated a redo entry.

Herein for any of time intervals T0-T2 that have a same predefined duration, redo generation rate 170 is a ratio that is a quantity of redo generated in that time interval divided by how long the time interval is. Depending on the embodiment, the quantity of redo may be measured as a count of redo entries or as a count of bytes that store the redo entries. For example, the unit of measurement of redo generation rate 170 may be bytes per second or entries per minute. In an embodiment, that quantity of redo generated in that time interval is itself an additional redo generation statistic 171 that may be used in a similar way as redo generation rate 170. Discussion herein of redo generation rate 170 generally describes both redo generation statistics 170-171.

### 1.5 Redo Generation Statistics

Depending on the embodiment, redo generation rate 170 is a moving mean (i.e. average) rate or a moving variance or moving standard deviation of a rate. Thus, depending on the embodiment, rate threshold 175 may detect either excessive redo generation or excessive volatility of redo generation, both of which are workloads that may cause deceleration (e.g. decreased throughput, increased latency) of components 100-102 and 191-192.

Each of database transactions 111-112 has its own redo generation rate. Redo generation rate 170 exceeding rate threshold 175 is a prerequisite of throttling database transaction 111. So long as redo generation rate 170 is not excessive, database transaction 111 will not be throttled. However, rate threshold 175 fluctuates as follows. In other words, rate threshold 175 is adaptive.

Redo generation rate 170 and rate threshold 175 each dynamically depend on a respective one of fluctuating rate statistics 161-164. Respective pairs of rate statistics 161-162 or 163-164 dynamically depend on respective circular buffers 141 and 143 whose contents fluctuate as follows. As discussed below, contents of global circular buffer 143 are based on all transaction circular buffers 141-142, which operate as follows.

### 1.6 Counters in Circular Buffer

Each of database transactions 111-112 is assigned and uses a distinct respective exactly one of transaction circular buffers 141-142 for the entire duration of the transaction. Each of transaction circular buffers 141-142 contains counters for redo data only from a distinct respective one of database transactions 111-112. That is: a) a database transaction does not use multiple transaction circular buffers; and b) a transaction circular buffer is private to a database transaction. As follows, a circular buffer may be operated as a sliding window in a fixed amount of memory.

In an embodiment, a circular buffer is a one-dimensional array of counters, each of which has a nonnegative integer value that is, for example, a count of either redo entries or bytes of redo data. As discussed earlier herein, an embodiment may have either or both of two redo generation statistics that are redo generation rate 170 and a redo generation quantity (i.e. size). For tracking redo generation rate, the circular buffer entry is a count of redo bytes generated in that time interval. For tracking transaction redo size in a different circular buffer, the circular buffer entry is the mean/variance of the transaction redo size for transactions that commit/end in that time interval. There may be multiple (e.g. two) circular buffers per session, which is one for each statistic that to track.

For demonstration in FIG. 1, the curved line indicates that counter C0 contains a count of redo entries or bytes of redo data that were generated, and counters C2-C3 and G1-G3 also contain respective counts of redo entries or bytes of redo data that were generated. As shown, circular buffers 141 and 143 contain respective sets of counters C1-C3 and G1-G3. Transaction circular buffer 142 contains counters (not shown) that are similar to those in transaction circular buffer 141.

Herein, any long duration may be divided into multiple contiguous time intervals such as time intervals T0-T2, and each distinct time interval is uniquely identified by a distinct respective integer, referred to herein as a time integer or a timestamp. A time integer may be used as an offset into the array of counters in a circular buffer. In other words, a time integer is all of: a) a unique identifier of a time interval, b) a unique identifier of an array element, and b) a unique identifier of a counter. For acceleration, using a time integer as an array offset performs random access to a counter in constant time.

A time interval is naturally identified by the combination of its lower and upper bounds that are the interval's start and end times. For example, a time interval may be uniquely identified by its start time. In an embodiment, a start time or an end time of a time interval is encoded as an integer whose value is a count of seconds elapsed since, for example, year 1970. In that case, the start time may be an integer that exceeds the capacity (i.e. maximum array size as a count of elements) of a circular buffer.

An arithmetic modulo operation converts any integer into a zero-based integer range that does not exceed the size of the circular buffer. For example, even though time interval T3 is not shown in FIG. 1, modulo returns offset 0 for both of time intervals T0 and T3. In an embodiment and as time progresses, values of higher order bytes of a sequence of time integers might not fluctuate or might very infrequently change. An embodiment may discard those higher order bytes, for example before performing modulo.

Herein even though time naturally advances, a circular buffer never overflows, which also means the capacity of the circular buffer never causes waiting (i.e. blocking) when using the circular buffer. Instead of waiting, the circular buffer will reset the counter that contains the oldest data and reuse the counter for a new current time interval.

For example, counters C0 and G0 may store counts for time interval T0 until time interval T3 occurs, which is when counters C0 and G0 instead store counts for time interval T3. During time interval T0, counter C0 may fluctuate in value and, only at the end of the time interval, counter G0 is calculated as discussed later herein. During time intervals T1-T2, counters C0 and G0 are immutable. Likewise, during time intervals T2-T3, counters C1 and G1 are immutable.

Current time 150 may advance (i.e. increase) and have a continuous sequence of integer time values contained within one time interval or within multiple time intervals. In the shown example, current time 150 is within time interval T2. In other words, time interval T2 is the current time interval.

Integer 155 is a time integer that is the value of current time 150. Integer 155 has two values that are a value before modulo and a value after modulo that is the value used as an offset into the array of transaction circular buffer 141. In the shown example, the value of integer 155 is two, which is used to identify offset 2 and select counter C1 in transaction circular buffer 141 when reading and writing counter C1.

At any time during time interval T2 and at least at the end of time interval T2, rate mean 161 is the statistical mean of counters C0-C2, regardless of what is the current time interval. In other words, rate mean 161 is a rolling average over a fixed-duration sliding window that operates as follows. The sliding window (not shown) always consists of the whole array of transaction circular buffer 141, which is all of counters C0-C2, regardless of whether counter C0 represents time interval T0 or instead represents unshown time interval T3.

### 1.7 Current Time Interval

At least at the end of the current time interval and optionally also (e.g. repeatedly) earlier in the current time interval, rate mean 161 is recalculated by summation of counters C0-C2 and then by division, regardless of whether rate mean 161 is arithmetic, geometric, or harmonic. That is, rate mean 161 is a quotient that is a ratio whose numerator is based on summation of counters C0-C2 in different ways depending on whether rate mean 161 is arithmetic, geometric, or harmonic. Brute force recalculation of a moving average is a non-incremental way whose performance characteristics are counterintuitive when compared to the state of the art that instead is an incremental way of calculating a rolling average. The incremental way is fast when dealing with a continuous (e.g. live or real-time) data stream. Instead of recalculating the average from scratch for an advance of time, the incremental way updates the previous average to derive a next average.

However, inaccuracy of a state of the art incremental rolling average is positively correlated with the ratio of: a) population size (e.g. current size of an ongoing and growing stream) to b) window size. As time elapses and a live data stream grows, the state of the art incremental way incurs a gradual accumulation of arithmetic rounding errors, which can become more significant as the stream grows.

Sensitivity to outliers in the stream is a further cause of inaccuracy in the state of the art incremental way. A larger window size makes the rolling average more sensitive to outliers, especially when outliers are concentrated in a particular duration. This can introduce inaccuracy, especially when the stream has become large and the window size is relatively small. Non-incremental rolling rate mean 161 is more accurate because it is recalculated from scratch at least once each time interval. The state of the art incremental way becomes increasingly inaccurate as rounding errors accumulate over time.

At any time during time interval T2 and at the end of time interval T2, rate variance 162 is the statistical variance or standard deviation of counters C0-C2, regardless of what is the current time interval. In other words, rate variance 162 is a rolling variance over the sliding window. Timing and frequency of recalculating rate variance 162 is similar to that of rate mean 161 as discussed above. In an embodiment, variance instead is computed incrementally using, for example, Chan's parallel algorithm.

### 1.8 Rate Measurement and Threshold

Depending on the embodiment, one of transaction rate statistics 161-162 is used as redo generation rate 170 and compared to rate threshold 175. In an embodiment, one or both of rate statistics 161-162 is implemented. In an embodiment, there is a separate respective rate threshold 175 for each of transaction rate statistics 161-162. In that case, exceeding either one of the two rate thresholds 175 is detected as excessive redo generation.

Redo generation rate 170 dynamically depends on one of fluctuating transaction rate statistics 161-162 that dynamically depend on transaction circular buffer 141 whose contents fluctuate as follows. Circular buffer 141 contains transaction counters C0-C2 that operate as follows.

Herein, the capacity of any of circular buffers 141-143 never causes waiting (i.e. blocking) when using the circular buffer. Instead of waiting, the circular buffer will reset the counter that contains the oldest data and reuse the counter for a new current time interval. For example at the beginning of time interval T3, counters C0 and G0 are reset and reused for time interval T3 as follows.

In an incrementing embodiment: a) resetting a counter entails zeroing the counter, and b) the counter can be incremented by the following adjustment magnitude. In a decrementing embodiment: a) resetting a counter entails replenishing the counter by assigning a predefined fixed positive number that is not less than the previous value of the counter, and b) the counter can be decremented by the following adjustment magnitude. In both embodiments, the adjustment magnitude is either an integer count of some redo entries generated, or an integer count of redo bytes generated, during the time interval of the counter.

The decrementing embodiment may operate as an allocation quota according to a token bucket algorithm as follows. In that case, the adjustment magnitude is a redo generation quota (i.e. limit) for each database transaction. The transaction redo counter of the current time interval may be repeatedly decreased until reaching zero, which indicates that the redo generation quota of the database transaction is temporarily exhausted. A transaction counter reaching zero may cause the database transaction to be throttled for the remainder of the current time interval. In that case, rate threshold 175 is zero and constant. By resetting the transaction counter, the quota is replenished at the beginning of each time interval.

Multiple adjustments of different respective magnitudes may occur to a same counter. In one scenario, execution of each of database statements 121-122 causes a respective adjustment to a same counter or, in another scenario, to separate respective counters. For example, database statement 121 may cause adjustment(s) to counter C0, and database statement 122 may subsequently cause adjustments to counters C0-C1. In a fully-supported extreme scenario, execution of database statement 121 adjusts counter C0 in multiple nonadjacent time intervals, such as time intervals T0 and T3, because execution of a long-running database statement 121 spanned so many time intervals that use of transaction circular buffer 141 wrapped around to reuse counter C0.

### 1.9 Adaptive Rate Threshold

Rate threshold 175 dynamically depends on one of fluctuating global rate statistics 163-164 that dynamically depend on global circular buffer 143 whose contents fluctuate as follows. Global circular buffer 143 contains global counters G0-G2 that operate as follows.

One transaction counter per ongoing transaction and one global counter are reset each time interval. For example, counters C0 and G0 are reset at the beginning of time intervals TO and T3 but not during time intervals T1-T2.

In an embodiment, adjustment of transaction counters C0-C2 is synchronous to (i.e. occurs within the critical path of) execution of database statements 121-122. In an embodiment, adjustment of global counters G0-G2 is asynchronous to execution of database statements 121-122. Global counters G0-G2 are adjusted as follows.

At the end of time intervals T0 and T3 but not during time intervals T1-T2, transaction counter C0 is exactly once, which is fast, added to or subtracted from global counter G0. That is at the end of time intervals T0 and T3, the value of transaction counter C0 is used as the adjustment magnitude of global counter G0 as discussed above.

Also at the end of time intervals T0 and T3 but not during time intervals T1-T2, a transaction counter (not shown) in other transaction circular buffer 142 is exactly once added to or subtracted from global counter G0.

In that way at the end of a time interval, a transaction counter from each ongoing database transaction 111-112 is combined to generate a value of a corresponding global counter. Global counters G1-G2 are adjusted in a similar way by using respective transaction counters C1-C2 at the end of respective time intervals T1-T2.

At the end of each time interval, global rate statistics 163-164 are regenerated from scratch, which entails recalculation using values from all global counters G0-G2 in global circular buffer 143.

Rate threshold 175 dynamically depends on one of fluctuating global rate statistics 163-164 as follows. Depending on the embodiment as discussed earlier herein, one of global rate statistics 163-164 is used as rate threshold 175. For example if transaction rate mean 161 exceeds global rate mean 163, then database transaction 111 is generating excessive redo, which may cause database server 101 to temporarily throttle database transaction 111 as discussed elsewhere herein.

### 1.10 Exemplary Throttling

In an embodiment, throttling of database transaction 111 is not initiated unless both thresholds 175 and 185 are exceeded during the current time interval. In an embodiment, throttling of database transaction 111 ceases when either of thresholds 175 and 185 is no longer exceeded. Lag numeric values 180 and 185 may cooperate as follows. In an embodiment discussed later herein, throttling of database transaction 111 is initiated or ceased based on capacity of shared buffer 132.

In RAM, shared buffer 132 may need flushing at a time that is scenario or embodiment specific, such as overflow of shared buffer 132 or one or all of database transactions 111-112, with redo in shared buffer 132, being a committed transaction. When replication (i.e. synchronization) is implemented, shared buffer 132 redundantly flushes its same contents to both of databases 191-192. Regardless of whether redo flushing to remote database server 102 is synchronous or asynchronous, there may be a latency of an effectively round trip that entails in sequence: 1) database server 102 receiving redo entries 130 as flushed from shared buffer 132, and 2) database server 102 applying redo entries 130 to database 192.

Lag duration 180 is a measurement of replication lag that is a (e.g. average, longest, or most recent) delay between when a transaction is applied to database 191 and when the transaction is later applied on database 192. This lag can occur due to the following example factors. Network latency is the time it takes to transport redo entries 130 to database server 102. Replication lag may be increased by either or both of transport lag and standby apply lag.

In an Oracle Data Guard embodiment, lag duration 180 is available in the MANAGED_STANDBY_STATUS relational database view. In an Oracle GoldenGate embodiment, lag duration 180 is available in the scriptable GoldenGate Command-Line Interface (GGSCI). In an embodiment, transaction throttling occurs only when lag duration 180 exceeds predefined lag threshold 185.

Execution of either of database statements 121-122 may cause locking of shared resource 190 that is a system resource of database server 101 that multiple database sessions may take turns using. Depending on the embodiment or scenario, shared resource 190 may be: a) an in-memory redo log buffer (not shown) from a buffer pool, b) an established network connection for redo log based replication to a standby database 192 at a standby database server 102, or c) a computer resource of standby component 102 or 192 for applying redo to database 192, such as a processing core, a memory region, or disk space.

For fairness by preventing priority inversion, starvation, and deadlock, throttling of database transaction 111 is not initiated if, for example, currently executing database statement 122 has locked (i.e. acquired) shared resource 190. In an embodiment, database server 101 synchronously decides whether or not to throttle database transaction 111 when database transaction 111 acquires or releases (i.e. unlocks) shared resource 190. In an embodiment, rate statistics 161-164 are recalculated when database server 101 begins a decision of whether or not to throttle database transaction 111.

### 2.0 Example Redo Generation Throttling Process

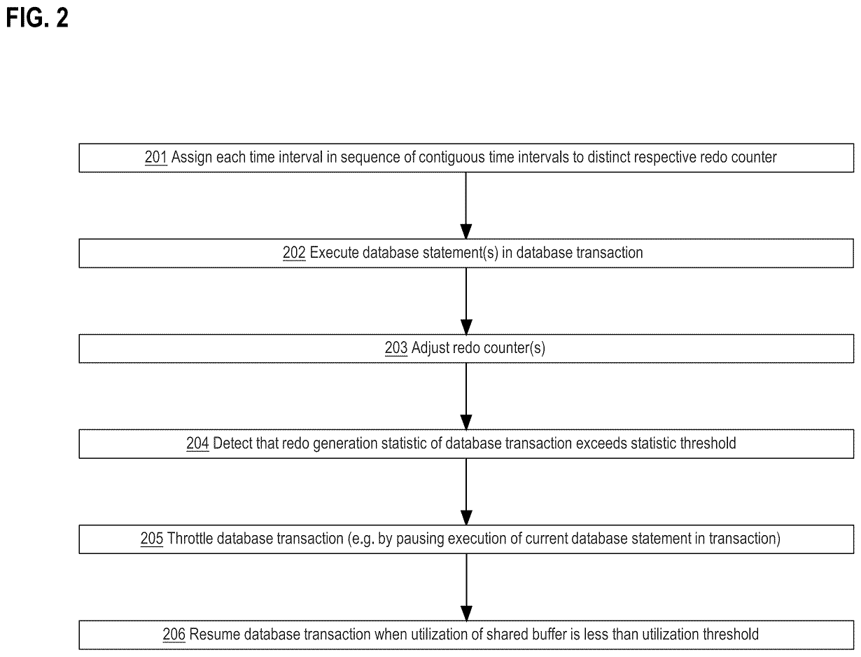

FIG. 2 is a flow diagram that depicts an example process that either of database servers 101-102 may perform to throttle a respective one of ongoing database transactions 111-112 to compensate for: a) an excessive redo generation rate of the transaction and b) in a replicated embodiment, excessive database replication lag duration 180.

Step 201 is preparatory and occurs before time interval TO, such as when database server 101 starts. Step 201 occurs before database transactions 111-112 begin. Step 201 assigns each time interval T0-T2 to distinct respective transaction redo counters C0-C2. Step 201 also assigns each time interval T0-T2 to distinct respective global redo counters G0-G2.

Step 202 executes database statements 121-122 in database transaction 111 as discussed earlier herein. Steps 203-204 are sub-steps of step 202 as follows.

Step 203 adjusts one, some, or all of transaction redo counters C0-C2 as discussed earlier herein. Step 204 detects that one of redo generation statistics 170-171 of database transaction 111 exceeds a respective statistic threshold such as rate threshold 175. As discussed earlier herein, there may be multiple redo generation statistics, and there may be multiple thresholds such as a quantity threshold (not shown). Step 204 may individually detect excessive database transactions based on their respective redo generation rates. For example in an embodiment: a) one occurrence of step 204 may detect that rate mean 161 exceeds a rate mean threshold, and b) another occurrence of step 204 may instead detect that a rate variance of database transaction 112 exceeds a rate variance threshold.

Step 205 throttles database transaction 111. Depending on the embodiment, step 205 pauses ongoing execution of a current database statement in database transaction 111 or pauses database transaction 111 between respective executions of database statements 121-122. In one scenario, a) step 205 throttles database transaction 111 in time interval T1 but not in time interval T2 or vice versa even though b) redo generation rate 170 is constant across time intervals T0-T2. This is because rate threshold 175 dynamically fluctuates.

In an embodiment, step 206 resumes (i.e. stops throttling) database transaction 111 based on capacity of shared buffer 132, which is when buffer utilization 134 of shared buffer 132 is less than a predefined utilization threshold. In this embodiment: a) shared buffer 132 has a fixed size, and b) buffer utilization 134 is a ratio whose numerator is the currently used capacity of shared buffer 132 and whose denominator is the total (i.e. used and unused) capacity of shared buffer 132. In that case, each of buffer utilization 134 and the predefined utilization threshold is a positive fraction whose value is at most one, also referred to herein as a percentage.

Other example embodiments that resume throttled database transaction 111 at other times are discussed earlier herein. Regardless of the timing and cause of resumption of database transaction 111, execution of database transaction 111 eventually runs to completion. In one scenario that spans many time intervals, a long-running database transaction 111 repeatedly transitions back and forth between throttled and unthrottled and eventually finishes executing.

### 3.0 Example Throttling Activities

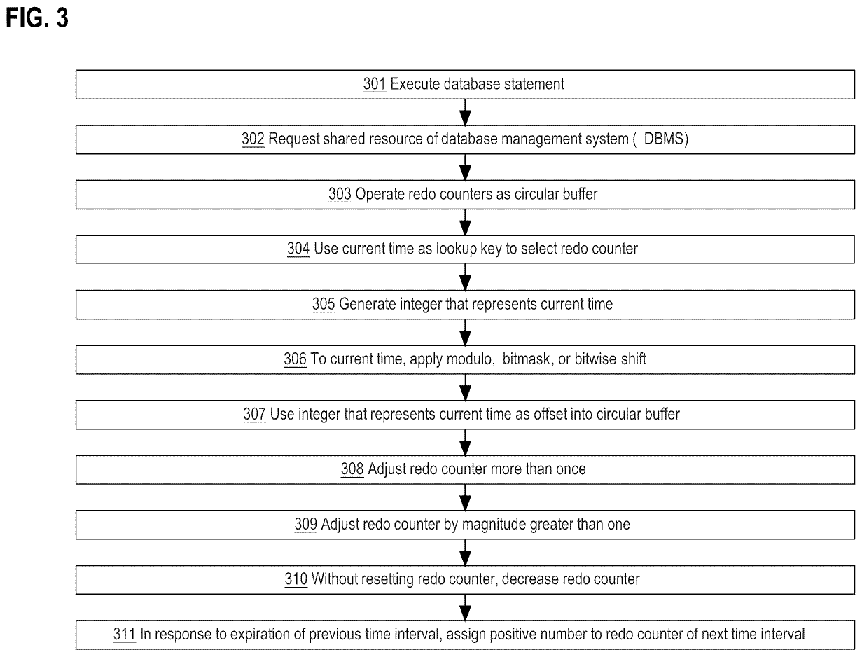

FIG. 3 is a flow diagram that depicts example activities that either of database servers 101-102 may perform to throttle a respective one of ongoing database transactions 111-112 to compensate for: a) an excessive redo generation rate of the transaction and b) in a replicated embodiment, excessive database replication lag duration 180. Some or all of steps 301-311 may complement or be combined with the steps of FIG. 2. Various embodiments implement some or all of steps 301-311.

Step 301 executes one of database statements 121-122 as discussed earlier herein. Step 302 is a sub-step of step 301. Step 302 requests shared resource 190 as discussed earlier herein.

Depending on the embodiment or scenario as discussed earlier herein, steps 303-310 may or may not be sub-steps of step 302. For example, steps 303-310 may occur at a different time before step 302. In any case, steps 303-310 operate as follows.

Step 303 operates multiple redo counters C0-C2 collectively as transaction circular buffer 141 as discussed earlier herein. Step 304 uses current time 150 as a lookup key to select redo counter C2. Steps 305-307 may be sub-steps of step 304 as follows.

Step 305 generates integer 155 that represents current time 150 as discussed earlier herein. To current time 150, step 306 applies modulo, bitmask, or bitwise shift to generate integer 155 as discussed earlier herein. Step 307 uses integer 155 as offset 2 for access into the counter array in circular buffer 141 as discussed earlier herein.

Step 308 adjusts redo counter C2 more than once during time interval T2 for database transaction 111 or for both database transactions 111-112 as discussed earlier herein. Steps 309-310 are sub-steps of step 308 as follows. In a single adjustment, step 309 adjusts redo counter C2 by a magnitude greater than one as discussed earlier herein. In the decrementing embodiment discussed earlier herein, step 310 decreases redo counter C2 without resetting redo counter C2.

In the decrementing embodiment, step 311 reacts to expiration of previous time interval T2 by assigning a positive number to redo counter C0 of next time interval T3 as discussed earlier herein.

### 4.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

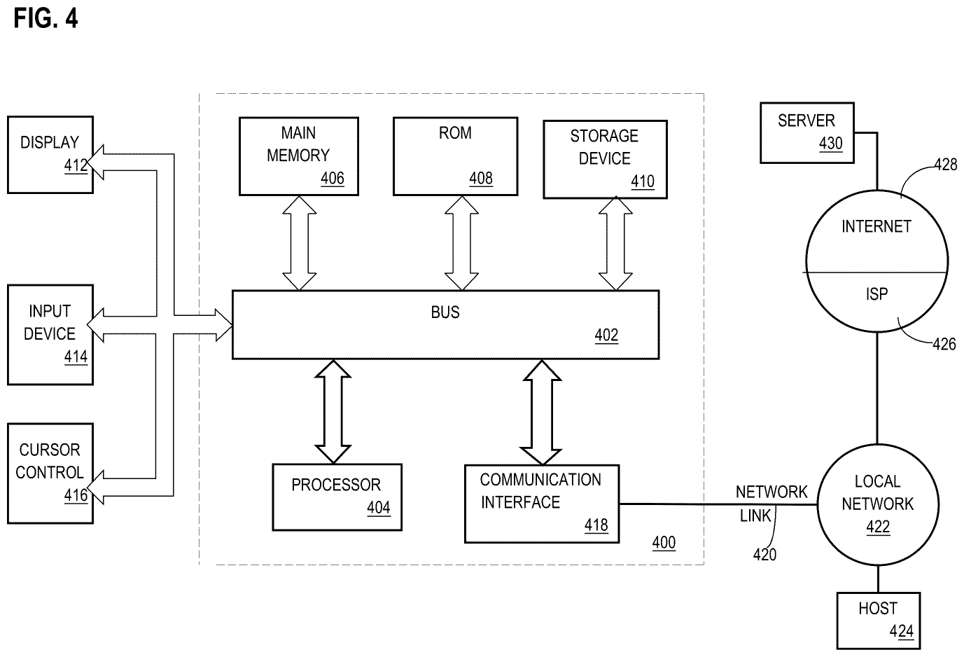

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

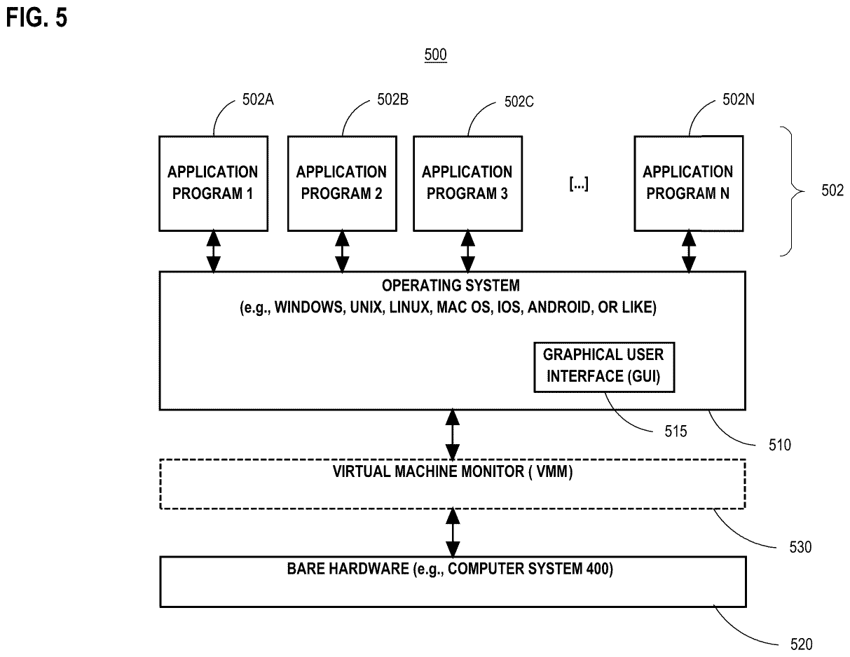

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
executing a sequence of database statements in a database transaction; and
decreasing replication lag of a database by:
a) detecting, during said executing, that a redo generation statistic of the database transaction exceeds a threshold, and
b) pausing, in response to said detecting, execution of one or more database statements in the database transaction, wherein the one or more database statements includes a database statement that can store a value in the database;
wherein the method is performed by a plurality of computers.

2. The method of claim 1 wherein:
the method further comprises assigning each time interval in a sequence of contiguous time intervals to a distinct respective redo counter of a plurality of redo counters;
said executing comprises adjusting at least one redo counter of the plurality of redo counters.

3. The method of claim 2 further comprising operating the plurality of redo counters as a circular buffer.

4. The method of claim 3 wherein said operating comprises:
generating an integer that represents a current time;
using the integer that represents the current time as an offset into the circular buffer.

5. The method of claim 4 wherein said generating comprises to the current time, applying at least one selected from a group consisting of: modulo, a bitmask, or a bitwise shift.

6. The method of claim 2 wherein:
said plurality of redo counters are a transaction plurality of redo counters that reflect only the database transaction;
the method further comprises combining each redo counter of the transaction plurality of redo counters to a distinct corresponding redo counter in a global plurality of redo counters.

7. The method of claim 6 wherein said detecting is based on at least one selected from a group consisting of:
a redo counter in the global plurality of redo counters and
an aggregate statistic of the global plurality of redo counters.

8. The method of claim 2 wherein:
the sequence of contiguous time intervals includes a previous time interval that is adjacent to a next time interval;
the method further comprises in response to expiration of the previous time interval, assigning a positive number to the redo counter of the next time interval.

9. The method of claim 2 wherein said adjusting a particular redo counter of the at least one redo counter of the plurality of redo counters comprises adjusting the particular redo counter by an amount greater than one or adjusting the particular redo counter more than once.

10. The method of claim 2 wherein said adjusting comprises using a current time as a lookup key to select a particular redo counter of the at least one redo counter of the plurality of redo counters.

11. The method of claim 2 wherein said adjusting comprises decreasing the at least one redo counter of the plurality of redo counters.

12. The method of claim 1 wherein:
the method further comprises executing a database statement of the one or more database statements;
said executing the database statement comprises requesting a shared resource of a database management system (DBMS);
said detecting is in response to said requesting.

13. The method of claim 1 wherein:
the one or more database statements include a previous database statement followed by a next database statement;
the method further comprises sequentially executing the one or more database statements;
said detecting occurs between executing the previous database statement and executing the next database statement.

14. The method of claim 1 wherein said detecting is in response to
utilization of a shared buffer in random access memory (RAM) exceeds a utilization threshold.

15. The method of claim 1 wherein the threshold is based on a count of bytes of redo, or the threshold is zero.

16. The method of claim 1 wherein said detecting is based on at least one selected from a group consisting of: a statistical mean and a statistical variance.

17. The method of claim 1 further comprising resuming the database transaction when utilization of a shared buffer in random access memory (RAM) is less than a utilization threshold.

18. One or more non-transitory computer-readable media storing instructions that, when executed by a plurality of computers, cause:
executing a sequence of database statements in a database transaction; and
decreasing replication lag of a database by:
a) detecting, during said executing, that a redo generation statistic of the database transaction exceeds a threshold, and
b) pausing, in response to said detecting, execution of one or more database statements in the database transaction, wherein the one or more database statements includes a database statement that can store a value in the database.

19. The one or more non-transitory computer-readable media of claim 18 wherein:
the instructions further cause assigning each time interval in a sequence of contiguous time intervals to a distinct respective redo counter of a plurality of redo counters;
said executing comprises adjusting at least one redo counter of the plurality of redo counters.

20. The one or more non-transitory computer-readable media of claim 19 wherein the instructions further cause operating the plurality of redo counters as a circular buffer.

21. The one or more non-transitory computer-readable media of claim 20 wherein said operating comprises:
generating an integer that represents a current time;
using the integer that represents the current time as an offset into the circular buffer.

22. The one or more non-transitory computer-readable media of claim 19 wherein:
said plurality of redo counters are a transaction plurality of redo counters that reflect only the database transaction;
the instructions further cause combining each redo counter of the transaction plurality of redo counters to a distinct corresponding redo counter in a global plurality of redo counters.

23. The one or more non-transitory computer-readable media of claim 18 wherein:
the one or more database statements include a previous database statement followed by a next database statement;
the instructions further cause sequentially executing the one or more database statements;
said detecting occurs between executing the previous database statement and executing the next database statement.

24. The one or more non-transitory computer-readable media of claim 18 wherein the instructions further cause resuming the database transaction when utilization of a shared buffer is less than a utilization threshold.

25. The one or more non-transitory computer-readable media of claim 18 wherein said detecting is in response to utilization of a shared buffer in random access memory (RAM) exceeds a utilization threshold.

26. The one or more non-transitory computer-readable media of claim 18 wherein the threshold is based on a count of bytes of redo, or the threshold is zero.
